(19) United States
(12) Patent Application Publication
(10) Pub. No.: US 2023/0359223 A1
(43) Pub. Date: Nov. 9, 2023

(54) DRONE CONTROL SYSTEM, DRONE, DRONE CONTROL METHOD, AND RECORDING MEDIUM

(71) Applicant: Panasonic Intellectual Property Corporation of America, Torrance, CA (US)

(72) Inventors: Kotaro SAKATA, Osaka (JP); Tetsuji FUCHIKAMI, Osaka (JP)

(21) Appl. No.: 18/216,062

(22) Filed: Jun. 29, 2023

Related U.S. Application Data
(63) Continuation of application No. PCT/JP2021/046620, filed on Dec. 16, 2021.

(30) Foreign Application Priority Data
Jan. 14, 2021 (JP) 2021-004051

(51) Int. Cl. G06Q 10/0631; G06Q 10/0833; G05D 1/10

(52) U.S. Cl. CPC G05D 1/101; G06Q 10/06315; G06Q 10/0833

(57) ABSTRACT

A drone control system includes a destination determiner and a movement instructor. The destination determiner determines, among standby places, a destination of a drone capable of delivering a package, based on a current location which is a location of the drone at present, standby place locations which are locations of the standby places, and predicted demand information regarding packages in the standby places. The movement instructor instructs the drone to move to the destination determined by the destination determiner.

### CROSS REFERENCE TO RELATED APPLICATIONS

This is a continuation application of PCT International Application No. PCT/JP2021/046620 filed on Dec. 16, 2021, designating the United States of America, which is based on and claims priority of Japanese Patent Application No. 2021-004051 filed on Jan. 14, 2021. The entire disclosures of the above-identified applications, including the specifications, drawings and claims are incorporated herein by reference in their entirety.

### FIELD

The present disclosure relates to a drone control system, a drone, a drone control method, and a recording medium that control a drone capable of delivering a package.

### BACKGROUND

Patent Literature (PTL) 1 discloses an optimal flight route generation method for setting, for a three-dimensional map data, waypoints that are to be reference points of a route database and generating, between the waypoints, a flight path that is optimal for an unmanned aerial vehicle having a flight altitude limit to fly with low energy consumption.

Moreover, PTL 2 discloses a method for providing security for a drone delivering a package of goods to a delivery destination.

### CITATION LIST

### Patent Literature

PTL1: Japanese Unexamined Patent Application Publication No. 2017-161315

### SUMMARY

### Technical Problem

A system that controls a drone capable of delivering a package, as disclosed in PTLs 1 and 2, is expected to deploy the drone to a suitable place for delivery.

The present disclosure provides a drone control system, a drone, a drone control method, and a recording medium that can deploy a drone to a suitable place for delivery.

### Solution to Problem

A drone control system according to an aspect of the present disclosure includes a destination determiner and a movement instructor. The destination determiner determines, among standby places, a destination of a drone capable of delivering a package, based on a current location which is a location of the drone at present, standby place locations which are locations of the standby places, and predicted demand information regarding packages in the standby places. The movement instructor instructs the drone to move to the destination determined by the destination determiner.

A drone according to an aspect of the present disclosure is capable of delivering a package, and includes the drone control system.

A drone control method according to an aspect of the present disclosure includes determining and instructing. In the determining, among standby places, a destination of a drone capable of delivering a package is determined, based on a current location which is a location of the drone at present, standby place locations which are locations of the standby places, and predicted demand information regarding packages in the standby places. In the instructing, the drone is instructed to move to the destination determined in the determining.

A recording medium according to an aspect of the present disclosure is a non-transitory computer-readable recording medium having recorded thereon a program for causing one or more processors to execute the drone control method.

### Advantageous Effects

The present disclosure has the advantage that a drone can be easily deployed to a suitable place for delivery.

### BRIEF DESCRIPTION OF DRAWINGS

These and other advantages and features will become apparent from the following description thereof taken in conjunction with the accompanying Drawings, by way of nonlimiting examples of embodiments disclosed herein.

FIG. 1 illustrates a configuration of a drone control system according to an embodiment.

FIG. 2 illustrates an example of a configuration of a drone according to the embodiment.

FIG. 3 is a block diagram illustrating the configuration of the drone control system according to the embodiment.

FIG. 4 illustrates a specific example of determination of destinations of drones by a destination determiner according to the embodiment.

FIG. 5 illustrates an example of operation of the drone and the drone control system according to the embodiment.

FIG. 6 is a flowchart illustrating an example of operation of the drone control system according to the embodiment.

FIG. 7 is a flowchart of a destination determination process by the destination determiner according to the embodiment.

FIG. 8 illustrates an example of standby place information according to the embodiment.

FIG. 9 illustrates another example of the standby place information according to the embodiment.

FIG. 10 illustrates still another example of the standby place information according to the embodiment.

FIG. 11 is a diagram for describing a process of determining a reachable range according to the embodiment.

FIG. 12 illustrates an example of destination candidates according to the embodiment.

FIG. 13 illustrates an example of drone information according to the embodiment.

FIG. 14 is a flowchart of a destination determination process by the destination determiner when a distribution of other drones according to the embodiment is used.

FIG. 15 illustrates an example in which part of function of the drone control system according to the embodiment is provided in a drone.

### DESCRIPTION OF EMBODIMENT

A drone control system according to an aspect of the present disclosure includes a destination determiner and a movement instructor. The destination determiner determines, among standby places, a destination of a drone capable of delivering a package, based on a current location which is a location of the drone at present, standby place locations which are locations of the standby places, and predicted demand information regarding packages in the standby places. The movement instructor instructs the drone to move to the destination determined by the destination determiner.

Accordingly, drone 101 can be easily deployed to a suitable place by using a predicted distribution of demand for picking up package B1. Moreover, since drone 101 can be easily deployed according to a distribution of demand for picking up package B1, drone 101 capable of delivering package B1 can easily stand by in the vicinity of a pickup location of package B1 to be delivered, and thus can efficiently deliver package B1.

For example, the predicted demand information may include information regarding a weight of each of the packages.

Accordingly, drone 101 can be easily deployed to a suitable place by using a predicted distribution of demand for picking up package B1 that relates to the weight of package B1, considering the load capacity of drone 101.

For example, at least one of the standby places may be provided with a charger for the drone. Moreover, the destination determiner may determine, among the standby places, the destination of the drone, further based on a current battery level which is a battery level of the drone at present.

Accordingly, drone 101 can be easily deployed to a suitable place based on the battery level of drone 101.

For example, the destination determiner may determine, among the standby places, destination candidates within a reachable range of the drone from the current location with the current battery level, and determine, among the destination candidates, the destination based on the predicted demand information.

Accordingly, drone 101 can be easily deployed to a suitable place based on the battery level of drone 101.

For example, the destination determiner may determine, among the standby places, the destination further based on information on an other drone different from the drone.

Accordingly, drone 101 to be moved can be deployed to a suitable place, considering information on an other drone 101 different from the drone 101 to be moved.

For example, the drone control system may further include a delivery completion determiner that determines whether the drone has completed delivery based on a state of the drone.

Accordingly, completion of delivery of package B1 can be appropriately determined.

For example, the delivery completion determiner may determine whether the drone has completed delivery based on a speed of the drone or a change in a load on the drone.

Accordingly, completion of delivery of package B1 can be determined without feedback from a recipient.

A drone according to an aspect of the present disclosure is capable of delivering a package, and includes the drone control system.

Accordingly, drone 101 can be easily deployed to a suitable place by using a predicted distribution of demand for picking up package B1. Moreover, since drone 101 can be easily deployed according to a distribution of demand for picking up package B1, drone 101 capable of delivering package B1 can easily stand by in the vicinity of a pickup location of package B1 to be delivered, and thus can efficiently deliver package B1.

A drone control method according to an aspect of the present disclosure includes determining and instructing. In the determining, among standby places, a destination of a drone capable of delivering a package is determined, based on a current location which is a location of the drone at present, standby place locations which are locations of the standby places, and predicted demand information regarding packages in the standby places. In the instructing, the drone is instructed to move to the destination determined in the determining.

Accordingly, drone 101 can be easily deployed to a suitable place by using a predicted distribution of demand for picking up package B1. Moreover, since drone 101 can be easily deployed according to a distribution of demand for picking up package B1, drone 101 capable of delivering package B1 can easily stand by in the vicinity of a pickup location of package B1 to be delivered, and thus can efficiently deliver package B1.

A recording medium according to an aspect of the present disclosure is a non-transitory computer-readable recording medium having recorded thereon a program for causing one or more processors to execute the drone control method.

Accordingly, drone 101 can be easily deployed to a suitable place by using a predicted distribution of demand for picking up package B1. Moreover, since drone 101 can be easily deployed according to a distribution of demand for picking up package B1, drone 101 capable of delivering package B1 can easily stand by in the vicinity of a pickup location of package B1 to be delivered, and thus package B1 can be efficiently delivered.

General or specific aspects of the present disclosure may be realized as a system, method, integrated circuit, computer program, computer readable recording medium such as a CD-ROM, or any given combination thereof.

Hereinafter, an embodiment is specifically described with reference to the Drawings. It should be noted that the embodiment described below shows a specific example of the present disclosure. The numerical values, shapes, materials, constituent elements, the arrangement and connection of the constituent elements, steps, the processing order of the steps, etc. shown in the embodiment below are mere examples, and therefore do not limit the scope of the present disclosure. Moreover, among the constituent elements in the embodiment below, constituent elements not recited in any one of the independent claims defining the broadest concept are described as arbitrary constituent elements.

### Embodiment

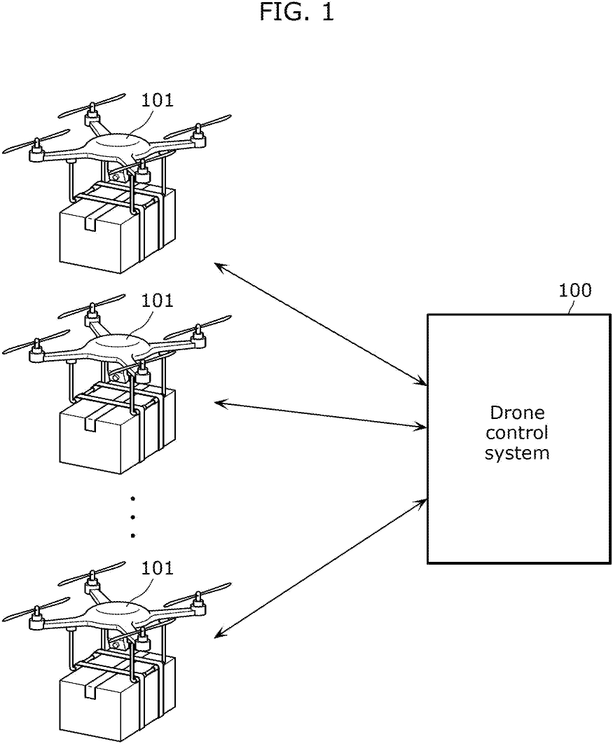

Hereinafter, a configuration of a drone control system according to an embodiment will be described. FIG. 1 illustrates a configuration of drone control system 100 according to the embodiment. As illustrated in FIG. 1, drone control system 100 is a system for controlling drones 101. For example, drone control system 100 is used by a delivery company that operates business of delivering package B1 by using drones 101. As an example, in the embodiment, description is carried out under the assumption that delivery of package B1 is carried out in association with a transaction between individuals.

### (1. Drone)

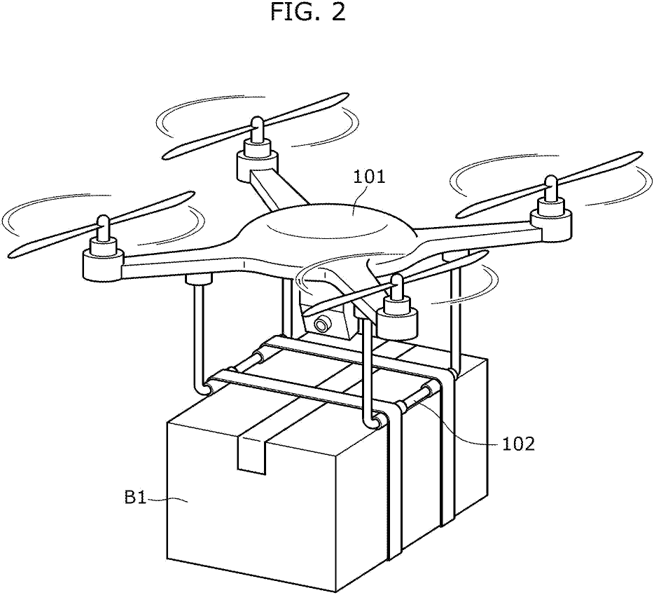

First, drone 101 to be used with drone control system 100 will be described in detail. FIG. 2 illustrates an example of a configuration of drone 101 according to the embodiment. Drone 101 is an unmanned aerial vehicle (UAV) and also an unmanned flying object that autonomously flies. Moreover, drone 101 is an electric drone that is driven by electricity as a power source. As illustrated in FIG. 2, for example, drone 101 includes holder 102 including arms, and is configured to be able to deliver package B1 by holding package B1 by holder 102. For example, when drone 101 receives a delivery instruction, drone 101 moves to a pickup location designated by the delivery instruction and holds, by holder 102, package B1 that has been prepared in the pickup location and is to be delivered. Then, drone 101 moves to a delivery destination designated by the delivery instruction and releases the hold of package B1 by holder 102 at the delivery destination, to thereby deliver package B1 to the delivery destination. Examples of each of the pickup location and the delivery destination may include a residential facility such as a detached house or an apartment house, a commercial facility, and a logistics center.

As described above, in the embodiment, drone 101 is used for delivering package B1 in a transaction between individuals. Specifically, in a transaction between individuals, a requester (sender) requests a delivery company to deliver package B1. For example, the request may be made through a website provided by the delivery company or through a dedicated application that is distributed by the delivery company and installed in an information terminal owned by the sender.

When a system (e.g., a server) operated by the delivery company receives the request for delivery of package B1, the system transmits a delivery instruction to drone 101 standing by in an area including the sender’s place of residence. When receiving the delivery instruction, drone 101 moves to the sender’s place of residence designated by the delivery instruction. Then, drone 101 holds, by holder 102, package B1 that has been prepared by the sender and is to be delivered.

Subsequently, drone 101 moves to a delivery destination designated by the delivery instruction, with package B1 held. Here, for example, the delivery destination may be a relay point such as a distribution center operated by the delivery company or may be a place of residence of a recipient of package B1. When the delivery destination is a relay point, drone 101 may be changed to another drone 101 at the relay point. Moreover, when the delivery destination is a relay point, a mobile entity other than drone 101, such as a truck, may deliver package B1 from the relay point to another relay point that is nearest to the place of residence of the recipient of package B1.

In a state in which drone 101 is not delivering package B1, drone 101 stands by at a standby place and waits for a delivery instruction. For example, when delivery of package B1 has been completed, drone 101 moves to a standby place designated by drone control system 100 and waits for the next delivery instruction at the standby place.

For example, the standby place is a space provided by the delivery company in area A1 in which the delivery company provides a delivery service. Area A1 represents an area in which the delivery company provides a deliver service for package B1. A single standby place may be included in area A1, or a plurality of standby places may be included in area A1. It should be noted that examples of the standby place may include a space provided for the purpose of sharing with a plurality of delivery companies and a space provided to the public by a public institution such as a government. In the embodiment, a charger for drone 101 is provided in the standby place. For example, charging of drone 101 is automatically performed by a method of physically connecting a charging connector to drone 101 or by contactless charging. It should be noted that not every standby place needs to be provided with a charger, and part of standby places may be provided with no charger.

Here, package B1 that can be delivered by drone 101 is limited according to the capacity of drone 101. For example, the load capacity of drone 101, that is, the weight of package B1 that can be delivered by drone 101 is limited. Moreover, for example, the shape, the size, etc. of package B1 that can be delivered by drone 101 are limited according to the shape, the size, etc. of holder 102.

For example, it is assumed that the weight of package B1 to be delivered is 8 kg and only drone 101 having a load capacity of 5 kg is present in a standby place around the pickup location of package B1. In this case, package B1 cannot be delivered unless drone 101 having a load capacity of 10 kg or more returns around the pickup location or unless drone 101 having a load capacity of 10 kg or more that is away from the pickup location is caused to come to the pickup location, for example. Accordingly, in delivery of package B1, it is important not only to simply deploy drone 101 to a standby place but also to deploy drone 101 according to the type of package B1 to a standby place.

### (2. Drone Control System)

Next, drone control system 100 will be described in detail. Drone control system 100 can communicate with drones 101 via a communication network or the like. For example, when drone 101 has completed delivery of package B1, drone control system 100 causes the drone 101 to move to a standby place by autonomous flight. In other words, drone control system 100 does not control a movement of drone 101 to a pickup location or a delivery destination of package B1 but controls a movement of drone 101 to a standby place.

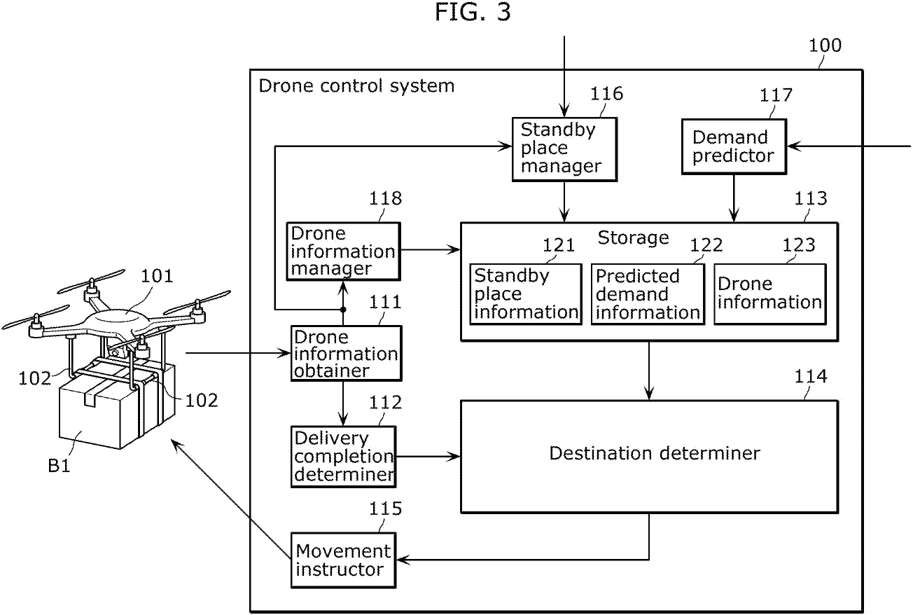

FIG. 3 is a block diagram illustrating the configuration of drone control system 100 according to the embodiment. As illustrated in FIG. 3, drone control system 100 includes drone information obtainer 111, delivery completion determiner 112, storage 113, destination determiner 114, movement instructor 115, standby place manager 116, demand predictor 117, and drone information manager 118.

Drone information obtainer 111 obtains drone state information from drone 101. For example, the drone state information indicates the state and the location of drone 101.

Delivery completion determiner 112 determines whether drone 101 has completed delivery of package B1, based on the state of drone 101 indicated by the drone state information obtained from drone 101.

Storage 113 stores standby place information 121 indicating standby place locations which are the locations of standby places, predicted demand information 122 indicating a predicted distribution of demand for picking up package B1, and drone information 123 indicating the states and a distribution (locations) of drones 101.

Destination determiner 114 determines a destination of drone 101 among the standby places indicated by standby place information 121. Specifically, destination determiner 114 determines a destination of drone 101 among the standby places, based on a current location which is the location of drone 101 at present, the locations of the standby places indicated by standby place information 121, the predicted distribution of demand for picking up package B1 indicated by predicted demand information 122, and the distribution of other drones 101 indicated by drone information 123.

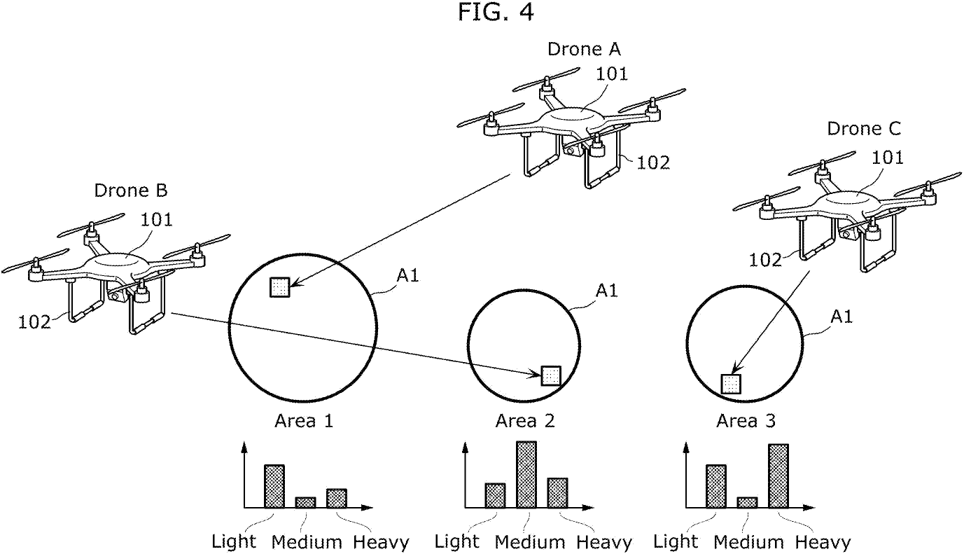

FIG. 4 illustrates a specific example of determination of destinations of drones 101 by destination determiner 114 according to the embodiment. In the example illustrated in FIG. 4, “area 1”, “area 2”, and “area 3” exist as three areas A1. Moreover, in the example illustrated in FIG. 4, a predicted distribution of demand for picking up package B1 in each area A1 is represented by a bar graph. In each of the bar graphs, “light” indicates a prediction result of demand for picking up package B1 weighing less than 5 kg, “medium” indicates a prediction result of demand for picking up package B1 weighing 5 kg or more and less than 10 kg, and “heavy” indicates a prediction result of demand for picking up package B1 weighing 10 kg or more. The predicted distribution of demand for picking up package B1 is calculated by demand predictor 117. Moreover, in the example illustrated in FIG. 4, “drone A”, “drone B”, and “drone C” exist as three drones 101. “Drone A” has a load capacity of 5 kg, “drone B” has a load capacity of 10 kg, and “drone C” has a load capacity of 20 kg. Furthermore, each of “drone A”, “drone B”, and “drone C” is not in a state of delivering package B1, and a reachable range of each of “drone A”, “drone B”, and “drone C” includes “area 1”, “area 2”, and “area 3”.

In the example illustrated in FIG. 4, demand for picking up package B1 weighing less than 5 kg is the highest in “area 1”, demand for picking up package B1 weighing 5 kg or more and less than 10 kg is the highest in “area 2”, and demand for picking up package B1 weighing 10 kg or more is the highest in “area 3”. Accordingly, in this case, destination determiner 114 determines a standby place in “area 1” as a destination of “drone A” having a load capacity of 5 kg. Moreover, destination determiner 114 determines a standby place in “area 2” as a destination of “drone B” having a load capacity of 10 kg. Furthermore, destination determiner 114 determines a standby place in “area 3” as a destination of “drone C” having a load capacity of 20 kg.

Thus, in the embodiment, destination determiner 114 first determines, among areas A1, area A1 with the highest demand for picking up package B1 as a destination of drone 101. It should be noted that destination determiner 114 may determine a destination of drone 101 not only simply referring to a predicted distribution of demand for picking up package B1, but also considering whether a demand for picking up package B1 has already been satisfied by another drone 101 being already deployed.

Movement instructor 115 instructs drone 101 to move to the destination determined.

Standby place manager 116 manages the states of the standby places. For example, standby place manager 116 periodically obtains, from each of drones 101, information indicating in which of the standby places the drone 101 is standing by, or, from each of the standby places, information indicating whether the standby place is vacant, and manages whether each of the standby places is vacant based on the information obtained.

Demand predictor 117 calculates a predicted distribution of demand for picking up package B1, and stores the calculation result as predicted demand information 122 in storage 113. In the embodiment, demand predictor 117 calculates, as the predicted distribution of demand for picking up package B1, a predicted distribution of demand for picking up package B1 that relates to the weight of package B1 for each area A1. Moreover, in the embodiment, the demand for picking up package B1 is demand for delivery of package B1 by a delivery company requested by a sender, that is, demand for collection of package B1 by drone 101 from a sender.

For example, demand predictor 117 calculates a predicted distribution of demand for picking up package B1 that relates to the weight of package B1 for each area A1, based on past order receiving data and/or past order placing data for delivery of package B1 by the delivery company. Here, for example, the past order receiving data and/or the past order placing data for delivery of package B1 may include not only data of package B1 that was delivered by drone 101 but also data of package B1 that was delivered by a mobile entity other than drone 101, such as a bicycle, a motorcycle, a car, a train, a ship, or an airplane. In other words, package B1 that was delivered by a mobile entity other than drone 101 in the past delivery may be included in the data, as long as package B1 is considered to be able to be delivered by drone 101 now or in the future.

Here, demand predictor 117 may calculate a predicted distribution of demand for picking up package B1 that relates to the weight of package B1 for each time period. For example, demand predictor 117 may calculate a predicted distribution of demand that relates to the weight of package B1 per hour or per day of the week. For example, past order receiving data and/or past order placing data for delivery of package B1 in arbitrary area A1 is assumed to indicate that, in the arbitrary area A1, the number of requests for picking up packages B1 of alcoholic beverages in a time period from 1 pm to 2 pm on Fridays tends to be relatively large. In this case, demand predictor 117 calculates a predicted distribution of demand showing a tendency that demand for picking up relatively heavy package B1 is high in the time period from 1 pm to 2 pm on Fridays in the arbitrary area A1.

Moreover, demand predictor 117 may calculate a predicted distribution of demand that relates to the variable weight of package B1 by using not only past order receiving data and/or past order placing data for delivery of package B1 but also real-time order receiving data and/or real-time order placing data for delivery of package B1.

Drone information manager 118 updates drone information 123, based on drone state information of drone 101 obtained from each of drones 101.

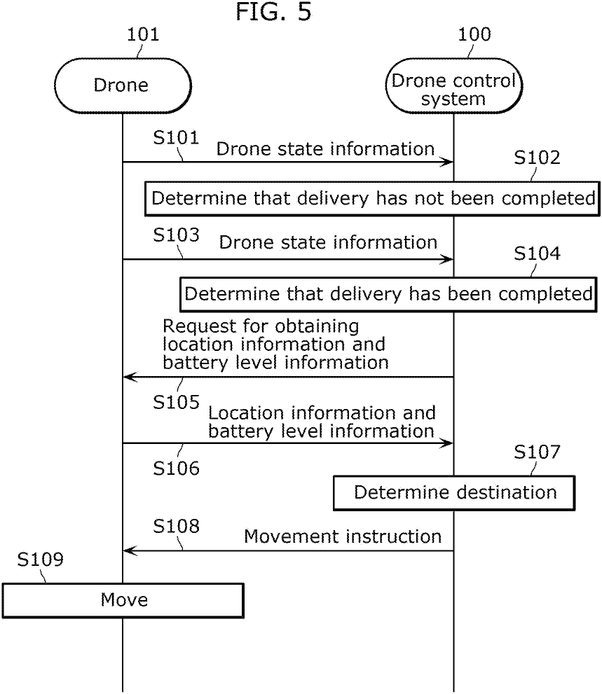

Next, the operation of drone control system 100 will be described. FIG. 5 illustrates an example of the operation of drone 101 and drone control system 100 according to the embodiment. It should be noted that, although the operation of drone control system 100 for a single drone 101 will be described below for simplification, the operation described below is actually performed for each drone 101.

As illustrated in FIG. 5, drone 101 periodically transmits drone state information to drone control system 100 (S101, S103). Moreover, drone control system 100 determines whether drone 101 has completed delivery of package B1 by using the drone state information received (S102, S104).

When drone control system 100 determines that drone 101 has completed the delivery of package B1 (S104), drone control system 100 transmits, to drone 101, a request for obtaining location information and battery level information of drone 101 (S105). When receiving the request, drone 101 transmits the location information and the battery level information to drone control system 100 (S106).

Next, drone control system 100 determines a destination by using the location information and the battery level information received (S107) and transmits, to drone 101, an instruction to move to the destination determined (S108). When receiving the instruction, drone 101 moves to the destination instructed (S109).

Here, an example is given in which drone control system 100 obtains the location information and the battery level information when drone control system 100 determines that the delivery of package B1 has been completed; however, the location information and the battery level information may be included in the drone state information and periodically transmitted from drone 101.

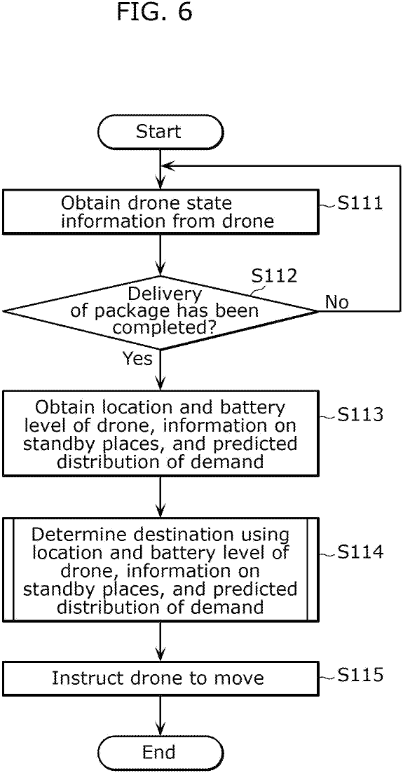

FIG. 6 is a flowchart illustrating an example of the operation of drone control system 100 according to the embodiment. First, drone information obtainer 111 obtains drone state information from drone 101 (S111).

Next, delivery completion determiner 112 determines whether drone 101 has completed delivery of package B1 by using the drone state information obtained (S112).

Specifically, for example, when a recipient receives package B1, the recipient pushes a button provided to drone 101. Then, information indicating that the button has been pushed is included in the drone state information. When the information indicating that the button has been pushed is included in the drone state information, delivery completion determiner 112 determines that drone 101 has completed the delivery of package B1. It should be noted that operation performed by the recipient when receiving package B1 is not limited to pushing a button and may be an input operation via a user interface such as a touch screen or a voice input. Moreover, these user interfaces need not be provided to drone 101, and the operation may also be an input through a mobile device, a smartphone, or the like owned by the recipient, for example.

Alternatively, delivery completion determiner 112 may determine whether the delivery of package B1 has been completed, based on the state of drone 101 indicated by the drone state information. For example, the drone state information may indicate the speed of drone 101, and delivery completion determiner 112 may determine whether the drone 101 has completed the delivery of package B1, based on the speed. Specifically, when the speed of drone 101 becomes zero (in a stopped state) and this state continues for a predetermined time or more, delivery completion determiner 112 determines that the delivery of package B1 has been completed.

Alternatively, the drone state information may indicate the weight of a load on drone 101, and delivery completion determiner 112 may determine that the delivery of package B1 has been completed when the weight of the load is changed (reduced) by a predetermined amount or more. Thus, delivery completion determiner 112 may determine whether drone 101 has completed the delivery of package B1, based on the weight change of the load on drone 101. It should be noted that delivery completion determiner 112 may combine two or more of the determination methods above.

When it is determined that the delivery of package B1 has not been completed (S112: No), drone information obtainer 111 obtains drone state information from drone 101 again after a predetermined time has elapsed (S111). Then, delivery completion determiner 112 determines whether drone 101 has completed the delivery of package B1 by using the drone state information obtained (S112).

When it is determined that the delivery of package B1 has been completed (S112: Yes), destination determiner 114 obtains the location and the battery level of drone 101 that has completed the delivery of package B1, information on standby places, and a predicted distribution of demand (S113). Specifically, information indicating the location and the battery level of drone 101 that has completed the delivery of package B1 is obtained from drone 101 by drone information obtainer 111. Moreover, the information on standby places and the predicted distribution of demand are stored as standby place information 121 and predicted demand information 122, respectively, in storage 113.

Next, destination determiner 114 determines a destination by using the location and the battery level of drone 101 that has completed the delivery of package B1, the information on standby places, and the predicted distribution of demand obtained (S114). The details of this process will be described later.

Finally, movement instructor 115 instructs drone 101 to move to the destination determined (S115).

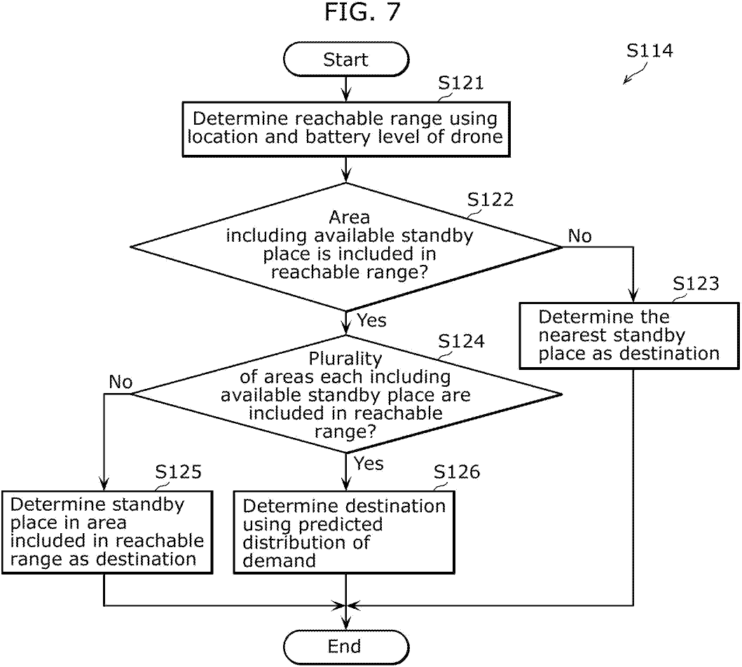

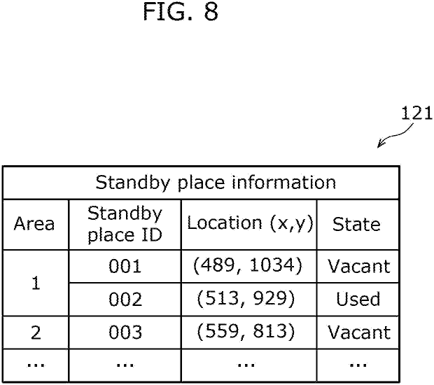

Next, a destination determination process by destination determiner 114 (S114) will be described in detail. Hereinafter, the destination determination process using a predicted distribution of demand and a battery level will be described. FIG. 7 is a flowchart of the destination determination process by destination determiner 114 according to the embodiment. FIG. 8 illustrates an example of standby place information 121 according to the embodiment.

As illustrated in FIG. 8, standby place information 121 includes, for each of standby places, area information indicating area A1 in which the standby place is provided, a standby place ID for identifying the standby place, location information (location (x, y)) indicating the location of the standby place, and usage state information indicating whether the standby place is being used or vacant (available). It should be noted that although the location information is represented by two-dimensional coordinates here, the location information may be represented by three-dimensional coordinates, an address, or the like.

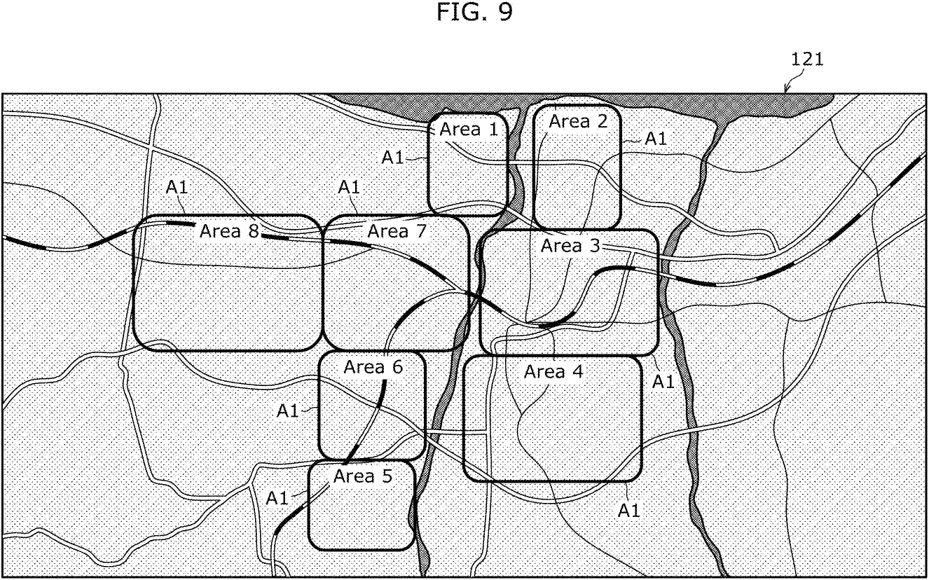

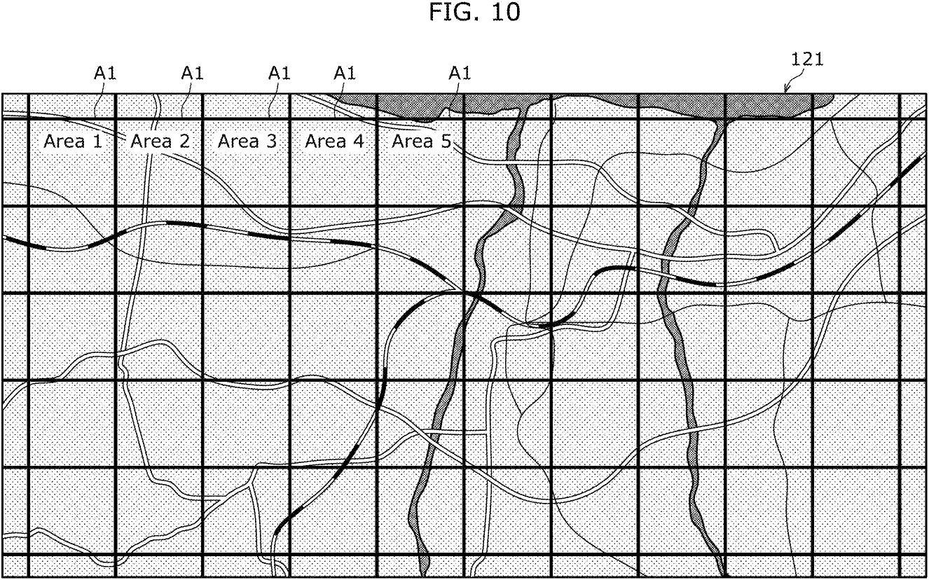

For example, the area information is represented by map information as illustrated in FIG. 9. FIG. 9 illustrates another example of standby place information 121 according to the embodiment. Although areas A1 are appropriately set by a delivery company in the embodiment, areas A1 may be set by dividing a map according to a predetermined rule, for example. FIG. 10 illustrates still another example of standby place information 121 according to the embodiment. In FIG. 10, areas A1 are set by dividing a map into a grid. Alternatively, areas A1 may be automatically set by a system, according to a degree of demand based on past order receiving data and/or past order placing data for delivery of package B1.

Moreover, the usage state information is appropriately updated by standby place manager 116. Specifically, for example, standby place manager 116 periodically obtains location information from each of drones 101, and when the location information obtained matches the location information of one of the standby places, standby place manager 116 determines that the one of the standby places is being used. It should be noted that standby place manager 116 may obtain, from each of drones 101, information indicating that the drone 101 is in a standby state and the standby place ID of the standby place that is being used by the drone 101, and update the usage state information based on this information obtained. Alternatively, standby place manager 116 may obtain information indicating whether a standby place is being used or vacant from a device provided in the standby place via a communication network or the like, and update the usage state information based on the information obtained.

As illustrated in FIG. 7, destination determiner 114 first determines a reachable range in which drone 101 can fly with the current battery level by using a current location which is the location of drone 101 at completion of delivery of package B1 and a current battery level which is the battery level of drone 101 at the completion of the delivery of package B1 (S121).

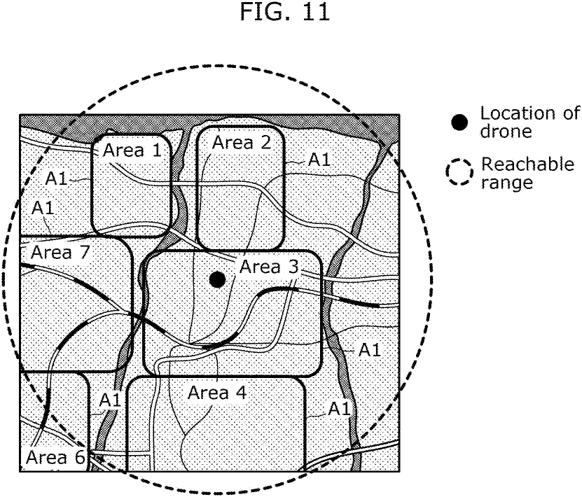

As illustrated in FIG. 11, for example, destination determiner 114 determines a reachable range as a circle having the current location of drone 101 as its center. FIG. 11 is a diagram for describing a process of determining the reachable range according to the embodiment. The radius of the circle increases in proportion to the battery level. It should be noted that the relationship between the radius of the circle and the battery level may be set in advance or may be determined based on past movement history of drone 101. When the movement history is used, the relationship between the radius of the circle and the battery level may be set for each drone 101 based on the movement history of the drone 101, and may be different for each drone 101.

Next, destination determiner 114 determines destination candidates included in the reachable range. Destination determiner 114 determines whether area A1 including an available standby place is included in the reachable range (S122). Here, area A1 including an available standby place is included in the reachable range may mean that the entire area A1 including an available standby place is included in the reachable range or that only part of area A1 including an available standby place is included in the reachable range but the available standby place of the area A1 is included in the reachable range. When area A1 including an available standby place is not included in the reachable range (S122: No), destination determiner 114 determines, as a destination, the nearest standby place that is located outside of area A1 but included in the reachable range (S123).

In contrast, when area A1 including an available standby place is included in the reachable range (S122: Yes), destination determiner 114 determines whether a plurality of areas A1, each of which includes an available standby place, are included in the reachable range (S124). When a plurality of areas A1, each of which includes an available standby place, are not included in the reachable range, that is, only a single area A1 including an available standby place is included in the reachable range (S124: No), destination determiner 114 determines the standby place in the single area A1 as a destination (S125).

Alternatively, when a plurality of areas A1, each of which includes an available standby place, are included in the reachable range (S124: Yes), destination determiner 114 determines a destination from destination candidates that are available standby places included in the reachable range by using a predicted distribution of demand (S126).

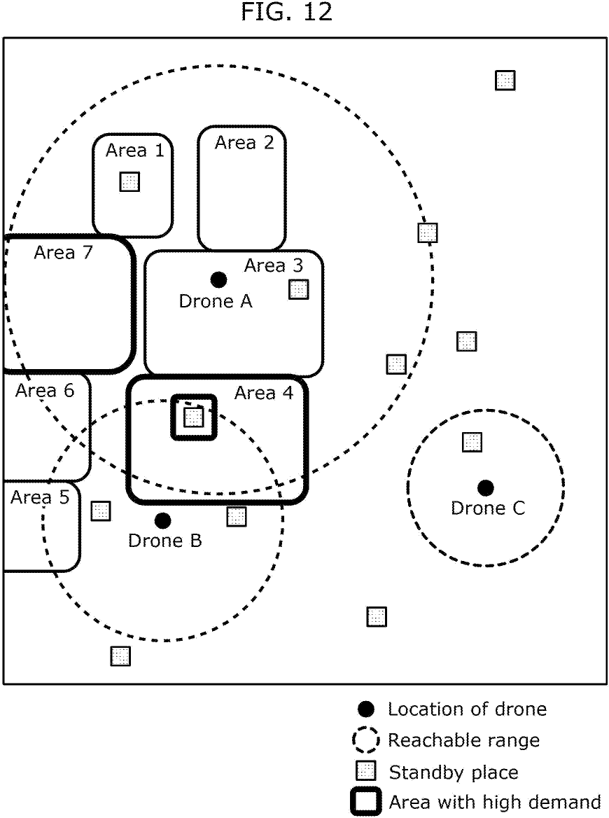

FIG. 12 illustrates an example of destination candidates according to the embodiment. It should be noted that FIG. 12 only illustrates available standby places as standby places. In this example, the reachable range of “drone A” includes six areas A1 that are “area 1”, “area 2”, “area 3”, “area 4”, “area 6”, and “area 7”. Moreover, in this example, three destination candidates exist for “drone A”. The three destination candidates are a standby place included in “area 1”, a standby place included in “area 3”, and a standby place included in “area 4”. Furthermore, in this example, the load capacity of “drone A” is 10 kg. In this example, demand for picking up package B1 weighing 10 kg or less is higher in “area 4” than that in “area 1” and “area 3”, according to a predicted distribution of demand for picking up package B1. Accordingly, in this example, destination determiner 114 determines, among the three destination candidates, the standby place in “area 4” as a destination.

Although the standby places in the reachable range, which is determined depending on the battery level, are determined as the destination candidates in the example described above, standby places included in a predetermined range may be determined as destination candidates and a destination may be determined from the destination candidates based on a predicted distribution of demand.

For example, when the battery level is greater than a predetermined threshold value, the battery level is not necessarily used. Moreover, in a specific area in which many standby places exist, the battery level is not necessarily used.

Moreover, destination determiner 114 may determine a destination by using information on other drones 101 (here, distribution of other drones 101) that are different from drone 101 for which the destination is determined. FIG. 13 illustrates an example of drone information 123 according to the embodiment. As illustrated in FIG. 13, drone information 123 indicates, for each drone 101, the drone ID for identifying the drone 101, the current location of the drone 101 (location (x, y)), the usage state of the drone 101, and the destination of the drone 101.

Here, the usage state includes a state in which drone 101 is standing by at a standby place (available), a state in which drone 101 is delivering package B1 (delivering), and a state in which drone 101 is moving to a standby place after the delivery of package B1 has been completed (returning). When drone 101 is delivering package B1, the delivery destination is set as the destination of drone 101, and when drone 101 is returning, a standby place in an area including the delivery destination is set as the destination of drone 101.

This information is periodically transmitted from drones 101 to drone control system 100. Although the current location and the destination are each represented by two-dimensional coordinates here, the current location and the destination may be each represented by three-dimensional coordinates, an address, or the like. Moreover, a standby place ID may be used when the current location or the destination is a standby place.

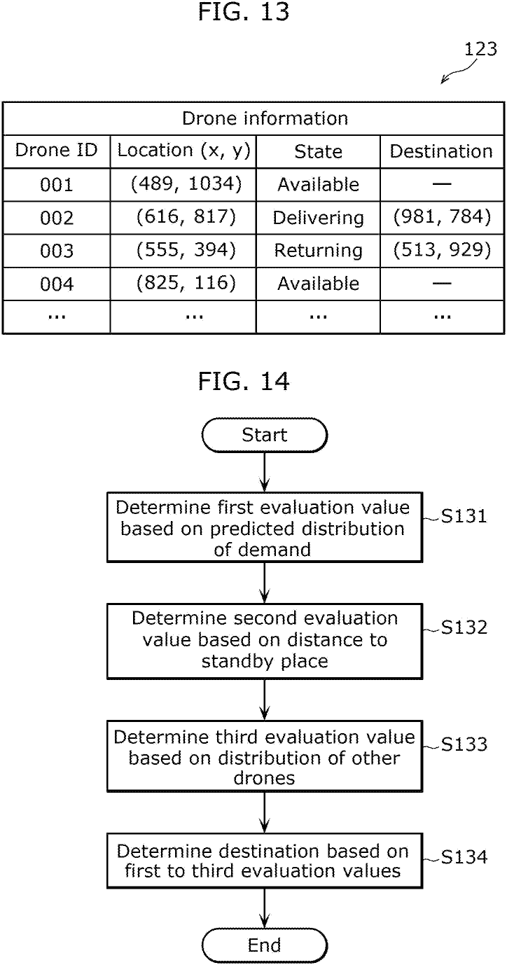

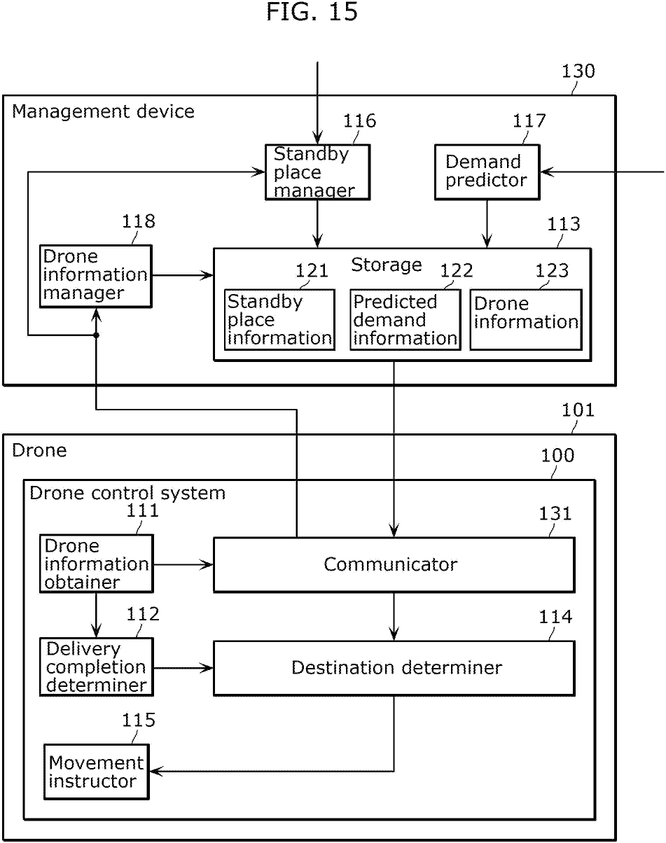

FIG. 14 is a flowchart of a destination determination process by destination determiner 114 when a distribution of other drones 101 according to the embodiment is used. First, destination determiner 114 determines a first evaluation value for each destination candidate based on a predicted distribution of demand (S131). Specifically, destination determiner 114 sets a higher first evaluation value for a destination candidate closer to area A1 with a high predicted demand, and sets the highest first evaluation value for a destination candidate inside area A1 with a high predicted demand. Moreover, when a degree of demand is indicated by demand prediction, destination determiner 114 sets a higher first evaluation value for a destination candidate closer to area A1 with a high degree of demand, and sets the highest first evaluation value for a destination candidate inside area A1 with a high degree of demand.

Next, destination determiner 114 determines a second evaluation value for each destination candidate based on a distance from the current location of drone 101 to the destination candidate (S132). Specifically, destination determiner 114 sets a higher second evaluation value for a destination candidate for which the distance is shorter. It should be noted that a time required for movement from the current location of drone 101 to a destination candidate may be used instead of the distance. In this case, destination determiner 114 sets a higher second evaluation value for a destination candidate for which the time is shorter.

Next, destination determiner 114 determines a third evaluation value for each destination candidate based on a distribution of other drones 101 (S133). Specifically, destination determiner 114 sets a lower third evaluation value for a destination candidate located in area A1 around which more other drones 101 are present, and sets the lowest third evaluation value for a destination candidate located in area A1 in which more other drones 101 are present. It should be noted that other drones 101 used for the determination here are other drones 101 that are available. It should be noted that destination determiner 114 may determine a third evaluation value based on the distribution of other drones 101 after a predetermined time has elapsed, considering other drones 101 that are currently moving.

Lastly, destination determiner 114 determines a destination based on first evaluation values, second evaluation values, and third evaluation values (S134). For example, destination determiner 114 adds up a first evaluation value, a second evaluation value, and a third evaluation value to calculate a final evaluation value for each destination candidate, and determines the destination candidate with the highest final evaluation value as a destination. It should be noted that a first evaluation value, a second evaluation value, and a third evaluation value may be weighted and then added up for calculating a final evaluation value.

In the description above, a first evaluation value and a third evaluation value are individually calculated. However, for example, the number of drones 101 in shortage in each area A1 may be calculated based on the predicted demand and the distribution of other drones 101, and an evaluation value corresponding to a first evaluation value and a third evaluation value may be determined based on the calculated number of drones 101 in shortage. In other words, destination determiner 114 sets a higher evaluation value for a destination candidate closer to area A1 in which the number of drones 101 is insufficient, and sets the highest evaluation value for a destination candidate in area A1 in which the number of drones 101 is insufficient.

As described above, drone control system 100 according to the embodiment determines, among standby places, a destination of drone 101, based on a current location which is the location of drone 101 at present, standby place locations which are the locations of the standby places, and a predicted distribution of demand for picking up package B1. Accordingly, drone control system 100 can easily deploy drone 101 to a suitable place by using the predicted distribution of demand for picking up package B1.

Here, the advantageous effect of drone control system 100 according to the embodiment will be described with comparison to a drone control system of a comparative example. The drone control system of the comparative example is different from drone control system 100 according to the embodiment in that the drone control system of the comparative example determines, as a destination, a standby place that is nearest to the current location of drone 101 at completion of delivery of package B1.

With the drone control system of the comparative example, when delivery of package B1 has been completed, drone 101 stands by at a standby place that is nearest to the current location of drone 101 regardless of demand for picking up package B1, and therefore a distribution of drones 101 may become uneven. When drones 101 are not deployed according to a distribution of demand for picking up package B1, drone 101 capable of delivering package B1 cannot stand by in the vicinity of a pickup location of package B1 to be delivered and it is necessary to wait for drone 101 capable of delivering package B1 to come, for example, and therefore package B1 cannot be efficiently delivered.

In contrast, as described above, with drone control system 100 according to the embodiment, drone 101 stands by at a standby place based on a distribution of demand for picking up package B1 after drone 101 has completed delivery of package B1, and thus drone 101 can be easily deployed according to the distribution of demand for picking up package B1. Therefore, drone 101 capable of delivering package B1 can easily stand by in the vicinity of a pickup location of package B1 to be delivered, and thus package B1 can be efficiently delivered.

Moreover, drone control system 100 determines a destination based on a current battery level which is the current battery level of drone 101. Accordingly, drone control system 100 can easily deploy drone 101 to a suitable place, considering the battery level of the drone 101.

Furthermore, drone control system 100 determines a destination based on a distribution of other drones 101. Accordingly, drone control system 100 can easily deploy drone 101 to a suitable place, considering the distribution of other drones 101.

Hereinabove, although drone control system 100 according to the embodiment has been described, the present disclosure is not limited to the embodiment.

Although destination determiner 114 determines a destination when delivery of package B1 by drone 101 has been completed in the embodiment, the present disclosure is not limited to this example. For example, destination determiner 114 may determine a destination while drone 101 is delivering package B1. For example, while drone 101 is delivering package B1, destination determiner 114 may predict the location and the battery level of drone 101 at completion of the delivery of package B1, and determine the reachable range of drone 101 by using the prediction result. For example, this aspect may be performed when package B1 can be delivered to a designated place, such as a delivery box, even when a recipient is not present, that is, when a recipient can certainly receive package B1 at a delivery destination.

Moreover, for example, destination determiner 114 may determine a destination for drone 101 standing by at a standby place. For example, this aspect may be performed when a predicted distribution of demand for picking up package B1 is changed while drone 101 is standing by.

Although demand predictor 117 calculates a predicted distribution of demand for picking up package B1 with reference to the weight of package B1 in the embodiment, the present disclosure is not limited to this example. For example, demand predictor 117 may calculate a predicted distribution of demand for picking up package B1 with reference to the shape of package B1. In other words, whether or not drone 101 can deliver package B1 may depend on not only the weight of package B1 but also the shape of package B1. For example, package B1 having a shape that cannot be delivered by drone 101 may exist depending on the shape or the like of holder 102 included in drone 101.

Similarly, for example, demand predictor 117 may calculate a predicted distribution of demand for picking up package B1 with reference to the size of package B1. In other words, whether or not drone 101 can deliver package B1 may depend on the size of package B1. For example, package B1 having a size that cannot be delivered by drone 101 may exist depending on the shape or the like of holder 102 included in drone 101.

For another example, demand predictor 117 may calculate a predicted distribution of demand for picking up package B1 with reference to the type of package B1. In other words, whether or not drone 101 can deliver package B1 may depend on the type of package B1. For example, when package B1 includes a fragile item, there may be a case where package B1 cannot be delivered by drone 101 depending on the flight performance of drone 101 since the fragile item in package B1 may possibly be cracked due to being shaken during delivery.

It should be noted that demand predictor 117 may calculate a predicted distribution of demand for picking up package B1 with reference to one parameter selected from the group of parameters consisting of the weight, shape, size, and type of package B1, or may calculate a predicted distribution of demand for picking up package B1 with reference to two or more of the parameters.

Moreover, in the embodiment, machine learning may be used for calculation of a predicted distribution of demand for picking up package B1 by demand predictor 117. For example, the machine learning is performed by using, as input, past order receiving data and/or past order placing data for delivery of package B1 and various parameters such as a time period. It should be noted that, since demand for picking up package B1 is ever-changing, the machine learning may be performed such that newer parameters and newer data have higher priority.

For example, although drone 101 is exemplified as an electric drone in the description above, a power source of drone 101 is not limited to electricity, and a known arbitrary power source such as hydrogen gas may be used for example. Moreover, drone 101 may be a hybrid drone using a plurality of power sources.

Furthermore, although drone 101 is used for delivering package B1 in a transaction between individuals in the embodiment, drone 101 may be used for delivering package B1 in a transaction between businesses or in a transaction between a business and a customer. It should be noted that demand for picking up package B1 is difficult to predict in a transaction between individuals, unlike a transaction between businesses and a transaction between a business and a customer for each of which demand for picking up package B1 is easy to predict. In this regard, drone control system 100 according to the embodiment has the advantage that drone control system 100 is suitable for delivering package B1 in a transaction between individuals since deployment of drone 101 can be optimized based on predicted demand information indicating a predicted demand for picking up package B1.

Moreover, although drone control system 100 is implemented as a single device (e.g., a server) separate from drone 101 in the example in FIG. 3, the function of drone control system 100 may be implemented by a plurality of devices capable of communicating with one another. For example, standby place manager 116, demand predictor 117, and drone information manager 118 may be provided to a device separate from drone control system 100, and drone control system 100 may obtain standby place information 121, predicted demand information 122, and drone information 123 that are generated by the device and store the information obtained in storage 113.

Moreover, part or all of the function of drone control system 100 may be provided in drone 101. FIG. 15 illustrates an example where part of the function of drone control system 100 according to the embodiment is provided in drone 101. In the example in FIG. 15, drone control system 100 in drone 101 includes drone information obtainer 111, delivery completion determiner 112, destination determiner 114, and movement instructor 115. Moreover, management device 130, such as a server, provided outside drone 101 includes storage 113, standby place manager 116, demand predictor 117, and drone information manager 118.

Furthermore, drone control system 100 includes communicator 131 that communicates with management device 130. Communicator 131 transmits drone state information and receives standby place information 121, predicted demand information 122, and drone information 123.

Moreover, each of processing units included in drone control system 100 and the like according to the embodiment is typically implemented as an LSI which is an integrated circuit. Each of the processing units may be individually implemented as a single chip, or a portion or all of the processing units may be implemented as a single chip.

Moreover, circuit integration is not limited to an LSI; the processing units may be implemented as dedicated circuits or generic processors. A field programmable gate array (FPGA) that is programmable after manufacturing of an LSI circuit, or a reconfigurable processor, whose connections and settings regarding circuit cells in an LSI circuit are reconfigurable, may be used.

Moreover, in the embodiment above, each constituent element may be configured in the form of specialized hardware, or may be implemented by executing a software program suitable for the constituent element. Each constituent element may be implemented by a program executing unit, such as a CPU or a processor, reading and executing a software program stored in a recording medium, such as a hard disk or a semiconductor memory.

Moreover, the present disclosure may be implemented as a drone control method that is executed by drone control system 100.

Moreover, all of the values used above are mere examples used for illustrative purposes; the present disclosure is not limited to the exemplary values.

Moreover, the division of the function blocks in each of the block diagrams is just an example. A plurality of the function blocks may be implemented as a single function block, one of the function blocks may be divided into a plurality of function blocks, or a portion of functions may be transferred to a different function block. Moreover, the functions of a plurality of the function blocks having similar functions may be processed by a single piece of hardware or software in parallel or by time-division.

Moreover, the order in which the steps are executed in each of the flowcharts is mere example presented for illustrative purposes; the steps may be executed in a different order. Furthermore, some of the steps may be executed at the same time as (in parallel with) other steps.

Hereinabove, a drone control system according to one or more aspects of the present disclosure has been described based on the embodiment; however, the present disclosure is not limited to the embodiment. Forms obtained by making various modifications to the embodiment that can be conceived by a person of skill in the art as well as other forms realized by combining some constituent elements in different embodiments, without departing from the essence of the present disclosure, are included in the one or more aspects of the present disclosure.

### INDUSTRIAL APPLICABILITY

The present disclosure is applicable to a drone control system, for example, a delivery system using a drone that can move autonomously, and the like.

1] A drone control system comprising:
a destination determiner that determines, among standby places, a destination of a drone capable of delivering a package, based on a current location which is a location of the drone at present, standby place locations which are locations of the standby places, and predicted demand information regarding packages in the standby places; and
a movement instructor that instructs the drone to move to the destination determined by the destination determiner.

2] The drone control system according to claim 1, wherein
the predicted demand information includes information regarding a weight of each of the packages.

3] The drone control system according to claim 1, wherein
at least one of the standby places is provided with a charger for the drone, and
the destination determiner determines, among the standby places, the destination of the drone further based on a current battery level which is a battery level of the drone at present.

4] The drone control system according to claim 3, wherein
the destination determiner determines, among the standby places, destination candidates within a reachable range of the drone from the current location with the current battery level, and determines, among the destination candidates, the destination based on the predicted demand information.

5] The drone control system according to claim 1, wherein
the destination determiner determines, among the standby places, the destination further based on information on an other drone different from the drone.

6] The drone control system according to claim 1, further comprising:
a delivery completion determiner that determines whether the drone has completed delivery based on a state of the drone.

7] The drone control system according to claim 6, wherein
the delivery completion determiner determines whether the drone has completed delivery based on a speed of the drone or a change in a load on the drone.

8] A drone capable of delivering a package, the drone comprising:
the drone control system according to claim 1.

9] A drone control method comprising:
determining, among standby places, a destination of a drone capable of delivering a package, based on a current location which is a location of the drone at present, standby place locations which are locations of the standby places, and predicted demand information regarding packages in the standby places; and
instructing the drone to move to the destination determined in the determining.

10] A non-transitory computer-readable recording medium having recorded thereon a program for causing one or more processors to execute the drone control method according to claim 9.
